(19) United States
(12) Patent Application Publication
(10) Pub. No.: US 2009/0272798 A1
(43) Pub. Date: Nov. 5, 2009

(54) Method of Membership Management

(76) Inventors: Anastasia Dedis, Lutz, FL (US); Panos E. Kontses, Lutz, FL (US)

Correspondence Address: WHITE-WELKER & WELKER, LLC, P.O. BOX 199, CLEAR SPRING, MD, 21722-0199, US

(21) Appl. No.: 12/404,658

(22) Filed: Mar. 16, 2009

Related U.S. Application Data
(60) Provisional application No. 61/038,257, filed on Mar. 20, 2008.

(51) Int. Cl. G06K 5/00

(52) U.S. Cl. 235/380

(57) ABSTRACT

Business method that allows a user to store the value of their membership on a card, to use when and where they wish to do so. This not only eliminates their financial risk, but also facilitates choosing one's own personal preferences out of their membership. A user can enjoy use tailored to a member's needs and receive value for money. The present invention enables a user to store the value of their membership on an Access Card so that one only pays for the services used. Key components of the business method of the present invention include: inter-member networking capabilities for the members through a personal web page and member and partner communication where each member can select the partners that interest them and give them commercial communication access through the member's personal page and in exchange the selected partners give these members offers/discounts in exchange for other non-monetary compensation.

### CROSS REFERENCE TO RELATED APPLICATIONS

This application claims priority from U.S. Provisional Patent Application Ser. No. 61/038,257, entitled “Method of Membership Management”, filed on 30 Mar. 2008. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to membership/subscription methods. More specifically, the present invention relates to a membership/subscription method that minimizes waste and provides rewards.

### BACKGROUND OF THE INVENTION

The most prevalent current membership model used by service industries is the time-lapse membership. Retailers, clubs, health and fitness centres, and many other service industries use it. Under the time lapse membership model, each member pays for a month, or a year, or some other length of time, and regardless of whether they used the membership or not, when the time lapses, payment is due. So the basis of the time-lapse membership is time lapsing regardless of use. If A Member considers that a member has no value from such a membership unless they use it, it becomes evident why so many people drop out of these memberships when they realize that it is a waste of their money if they cannot maintain full use. So these time-lapse memberships are believed to be the main reason people fail to maintain a membership. Time-lapse memberships are a blanket approach to cover people's needs with non-existent personalization capabilities and as a result normal people with full lives find it very difficult to use the membership adequately in order to get their money's worth and as a result end up feeling that they are paying for a membership they do not use and eventually quit.

Recent studies have shown that traditional time-lapse memberships work only for the few enthusiasts. For the majority of people—who expect to complement and not dominate their lives—time-lapse memberships do not work. This results in huge drop out rates. In the health and fitness club industry as an example: We all want to be healthy, care about the way we look and understand the value of being fit, but the market attributes member failure to lack of discipline, lack of willpower, laziness or simply human nature, which is simply not the main cause of attrition. Quite the opposite: the busier we are, the more difficult we find it to maintain a fit lifestyle. While we would like to be fit and healthy, we are not offered a feasible way to maintain a membership. Because all this time, the market—failing to recognize this dilemma—has tried to squeeze everyone into the traditional membership offerings. Ex-members state as the main reason for quitting the fact that they could not use the facilities as often as they liked and so they were unable to get value out of their membership.

Let's look at a fitness member's experience that is very similar to member experiences in other industries too. The member experience under the time-lapse membership model starts with a feeling of happiness. Members are happy when they buy a membership, but guided by the perception that is hard work one seeks quick results and also wants to get their money worth and not waste a day on the ticking clock. So, filled with beginner's enthusiasm, members start working out intensively and push their bodies too hard because that's what they see other members do in the club. Every time members don't use our membership they feel that they have wasted their money and failed to meet their goals. Members become exhausted trying to maintain focus and adhere to the schedule. They pay their dues for a few more months hoping that they will eventually find the time to get back in there and use the club again. They end up quitting once they realize that they cannot maintain this pace unless they make a top priority in their lives and that they are paying for nothing since they are not able to FULLY use the club. Members arrive at the conclusion that they cannot be fit and fulfil the responsibilities of a normal life at the same time, at least not by using a fitness club membership and they leave disappointed. Whatever results they achieved will soon disappear following drop out.

Buying into the myth that it requires discipline, hard work, sweat and willpower, members blame themselves for not ‘making it’. The whole experience leaves them with a bad taste. They feel that they have wasted their time and money and end up questioning their ability to ever become fit. They end up feeling puzzled as to how to approach their needs, and the club is also puzzled. This cycle repeats itself many times over the years before the member finally realizes that nothing changes and this way simply does not work.

Others have proposed alternative membership methods, but they have all failed to achieve market penetration and have failed for various reasons and shortcomings. For Example, U.S. Pat. No. 6,594,640 teaches a system and method for operating a reward points accumulation and redemption program wherein a user earns reward points from a plurality of independent reward points issuing entities, with each tracking the user's earned reward points in a user reward point account stored on a rewards server (such as a frequent flyer account or a credit card loyalty account). On selective request by the user, a trading server accumulates some or all of the user's earned reward points from the reward servers and credits the accumulated points into a single reward exchange account associated with the user. The user may then select an item for purchase with the accumulated reward points. The item is provided to the user in exchange for a subset or all of the reward points.

U.S. Pat. No. 6,368,215 teaches a slot card issued by a slot club, or a membership card in another incentive award program that is also capable of being used as phone calling card is provided. Free calling time is credited to the member's card account in response to the playing of the slot machine or utilizing the respective service. After incentive points are awarded, the member may use the membership card as a prepaid phone calling card, whereby the member's account is debited for the cost of the call.

U.S. Pat. No. 4,831,241 teaches a control system for a health club which stores user records including user activity data in order to monitor and control use of the club's facilities. A central controller includes a memory for storing the user records including attendance data and accounting data, and a main control which is responsive to the user record data for determining whether a user is authorized to use the club's facilities. The central controller is coupled to various club facilities and equipment such as a computerized scale to prevent use thereof if a user is not authorized. The central controller also stores user history data such as user weight data for the computerized scale to alleviate data storage problems.

U.S. Pat. No. 4,831,242 teaches a control system for a health club which stores user records including user activity data in order to monitor and control use of the club's facilities. A central controller includes a memory for storing the user records including attendance data and accounting data, and a main control which is responsive to the user record data for determining whether a user is authorized to use the club's facilities. The central controller is coupled to various club facilities and equipment such as a computerized scale to prevent use thereof if a user is not authorized. The central controller also stores user history data such as user weight data for the computerized scale to alleviate data storage problems.

What is needed is a membership model that benefits both buyers and sellers in the marketplace that can replace the time-lapse membership model.

What is needed is a membership model that calculates and stores the value purchased by the member—that through non-usage would be lost under time lapse memberships—and provides alternative ways to spend this stored value to enjoy a wide variety of products and/or services, both in and out of the club (the “Homeclub”) where the membership was purchased. A model that gives consumers who purchase a membership at a specific “Homeclub”, simultaneously membership to a Larger Club that the Homeclub has chosen to participate in. This Larger Club includes a Network of similar clubs in other locations and a Network of Partner merchants. Each member can dynamically select the Partners of interest to him/her and form a Larger Personal Network where membership value can be used for services, discounts and special offers in exchange for communication access granted by the member to the selected Partners.

### SUMMARY OF THE INVENTION

The present invention is a business method that allows a user to store the value of their club membership on a personal account, to use when and where they wish to do so. This not only eliminates their financial risk, but also facilitates choosing one's own personal preferences out of their club membership. A user can enjoy use tailored to a member's needs and receive value for money. The present invention enables a user to store the value of their club membership on a personal account so that one only pays for the services used. Other key components of the business method of the present invention include: inter-member networking capabilities for the members through a personal web page and communications between members and selected partners.

The System features a model structured around flexible usage of club services in order to offer members tangible value, beyond old-fashioned time-lapse club membership. Memberships often result in a difference between value purchased and value received. Members of the same club may purchase identical memberships but while some use the club on a regular basis, others may use it hardly at all. Still they all pay the same dues.

As most memberships offer unlimited use of the facilities, only those members using the club everyday achieve optimum value for money. This creates a value imbalance for most members, which escalates the more dormant the member is. This is why the present invention has created the Credit: as a standard of value. Credits enable members to pay for what they actually use and the club to maximize income through higher retention thereby increasing per head income dramatically. This is based on the premise that for every day one does not use their membership; the corresponding value should be saved in their personal account for usage at a later date.

Credits ensure that the member does not lose any money because it is stored for future use. Members can use a wide variety of products and services both in and out of the club. The essence of the present invention is that members will only be charged for what they use. Credits enable members to fully personalize their membership. Credits offer membership flexibility creating enjoyment through alternative services. Credits enable the club to offer a membership that follows the members wherever they go. The present invention enables participation in a global network of leading Clubs united under a strong branded platform.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a Membership Experience under common membership methods know and used in the prior art;

FIG. 2a illustrates the zero sum game of the prior art and FIG. 2b the result of application of the method of the present invention and where the present invention is applied in the enrollment/dropout process;

FIG. 3 illustrates a proprietary membership calculator of the present invention designed per specific industry;

FIG. 4 is a schematic that illustrates the members within the system and their connectivity;

FIGS. 5a and 5b are pie charts illustrating the membership offering comparison between prior art system and the present invention;

FIG. 6 illustrates the redemption chart of the present invention; and

FIG. 7 illustrates system's Network Access Rights.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The Method and System facilitates members to receive the value they purchased from a time-lapse membership by transferring the value of each membership in a personal container where the value purchased by each member is stored and remains at his/her disposal until spent. The amount paid by the member for their membership is converted to Value Purchased by converting every payment to Value Units using a standard to each industry, proprietary secret formula. These Value Units are then stored in a personal account that is accessible to its owner through the Internet, a card, a cell phone or any other gadget. The owner of these points is the member and the issuer of these points is the business or club selling the membership. The facilitator is the system operator. A Ring of Partners is formed around each membership. This Ring is comprised of businesses, which in exchange to receiving access to each member have granted permission to the Issuer to issue discounts vouchers in exchange for Value Points.

‘Price’ Lists are established by the Issuer for In-Club products or services that can be purchased by the members by spending Value Units only and for products or services that can be purchased by spending both dollars and Value Units. The member can spent their Stored Value in a variety of services in and out of the business, on the Internet and in the physical world, until it is completely used up by the member. Thereby ensuring that Value Purchased=Value Received. Also ensuring Full Personalization at all times during the membership duration. Each member can decide how to spend their Stored Value at any time. With such a variety of options offered to members through the club and its partners, member Accessibility to spend the Value Purchased increases dramatically both in and out of the club. Value is oftentimes lost when members can only receive value by going to a pre-specified location or by only having access to limited services. By offering alternatives to receive (spend) value purchased the member is much more likely to be able to receive their money's worth. Thereby making the membership more valuable as it becomes an Enhancement to the member's Life.

The Steps/Components of the invention: are Account/Card Types per industry established and variables for Account/Card Types. Different commitment levels are measured in duration of membership and frequency of weekly use. Payment options include pay-as-A Member-go or Direct Debit, Cash, or Pre-financed.

A Member chooses account/card type to store membership on. VP (Value Purchased) is translated to Value Units (Credits) using the specific to the industry formula used by the System for the selected account type. Membership Value stored in personal container in points (Credits). Containers can be personal, couple, family, or household. The system defines accrual rules, redemption rules, and redemption periods. The system provides for price lists to be established by each Home Club and entered in the System (in Credits for some services, and Credits combined with cash for other services) for redemption use by members. The system provides for these participants: Issuer=Home Club; Owner of Membership/Account/Card=Member; Facilitator=Present Invention Website; Network of Clubs=All the Home Clubs participating in the System; Network of Partners=All the businesses that accept redemption of Credits in exchange for discounts; Network of partners is formed around each club (partners gain communication access to members in exchange for discounts offered.). The System classifies Network Clubs, provides for Network Access Rights, provides for privileges offered to members, enables rewards for healthy choices to be offered to members and provides for compensation for: Past disappointments, Current System failures, Innovative suggestions.

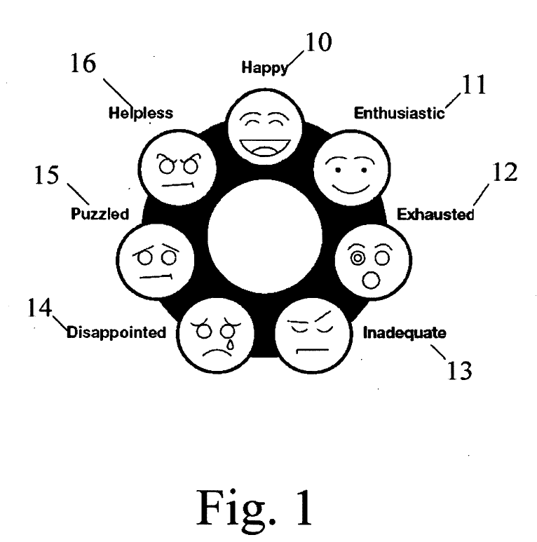

Services offered by the System include a System website, Partners, e-shop, Concierge, Ombudsman. Instruments provided by the System inlcude: the on-line ombudsman service, the Success Foundation: an online Marketing and Training Facility for club employees and managers, the Innovation Awards and the Member's Protection Bond which is a pool of ‘goodwill’ to ensure members are always covered. Now referring to FIG. 1, The system's bedrock concept of consumer empowerment traces back to the belief of its inventors that memberships, the way they are structured and offered, address the issues of the few, while ordinary men and women need an altogether different approach in order to get their money's worth from any membership. Modern lifestyles are plagued by time deficits and distractions. As a result we find that even the best memberships ‘fly by’ our lives before we are able to get our money's worth. Very few of us are able to break even when we buy a membership. The membership cycle most of us go through when enrolling in a club looks like this: Happy: We start out happy 10; Enthusiastic 11: Filled with enthusiasm we start with as much use as possible; Exhausted 12: We become exhausted trying to fit it in our lives and eventually end up giving up when we realize that we cannot keep up a reasonable use of the membership to get our money's worth; Inadequate 13: We feel we did not make it, that somehow we were not disciplined enough, we have somehow failed to do what we had planned; Disappointed 14: The whole experience left us with a bad taste. We feel that we failed and wasted time and money and doubt we can ever do this; Puzzled 15: We want to do this but how? Maybe it is not for us. Maybe we'll try again next year. The club is also puzzled thinking that they have the best club possible, the best staff possible and still it makes no difference. Members cannot enjoy what they don't use; and Helpless 16: We see no solution in sight. We want to do this but the only way is to try again the same way and hope for different results. Maybe this time we'll be better! The cycle repeats itself with every attempt we make to embrace a membership and make it part of our lives. And round and round we go until we finally give up. Huge attrition rates are the result.

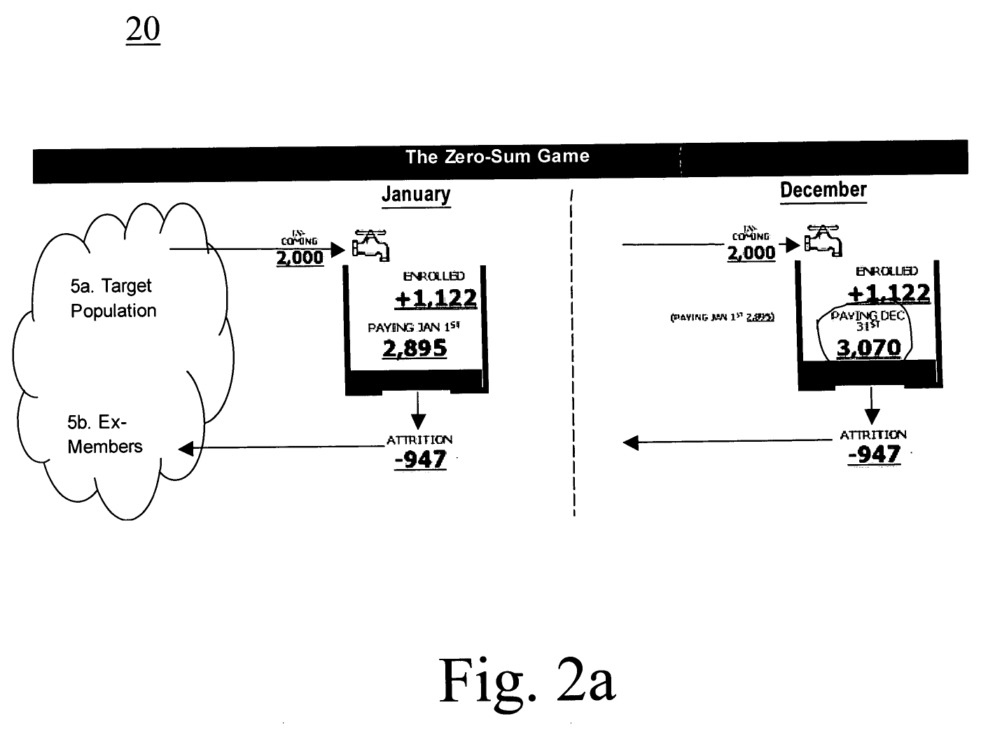

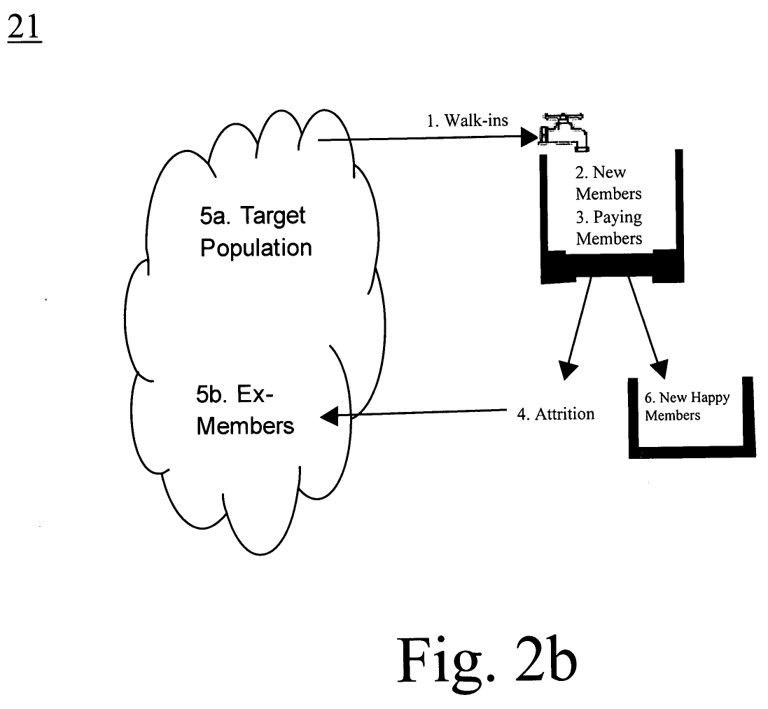

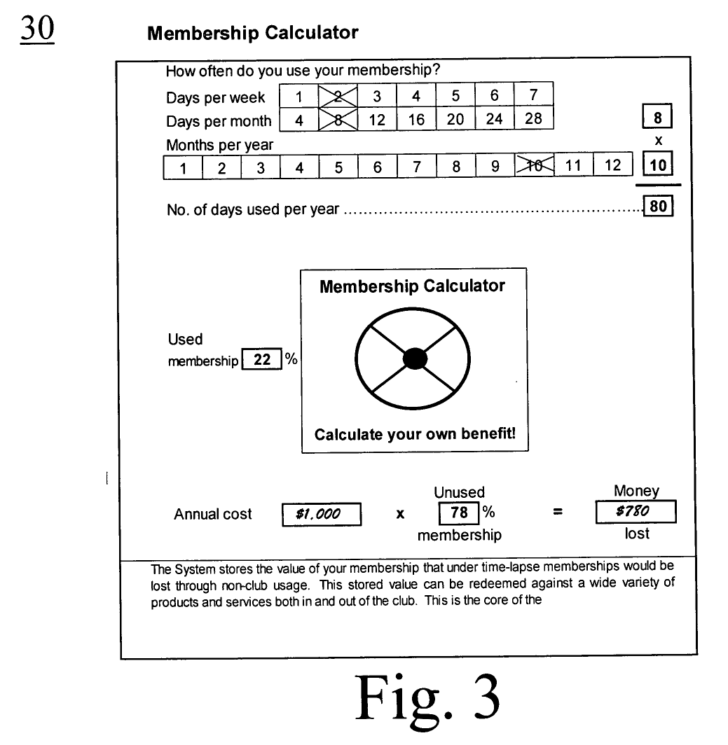

The principal idea of this invention is Consumer Benefit. The System features a model structured around flexible usage of club services in order to offer cardholders tangible value, beyond old-fashioned time-lapse club membership. Now referring to FIGS. 2a and 2b, Memberships often results in a difference between value purchased 20 and value received. Members of the same club may purchase identical memberships but while some use the club on a regular basis, others may use it hardly at all as shown in the membership calculator 30 illustrated in FIG. 3. Still they all pay the same dues. As most memberships offer unlimited use of the facilities, only those members using the club everyday achieve optimum value for money. This creates a value imbalance for most members, which escalates the more dormant the member is.

This is why the present invention has created the Credit: as a standard of value. Credits enable members to pay for what they actually use and the club to maximize income through higher retention thereby increasing per head income dramatically. The present invention provides that “for every day A Member do not use a Member's membership, the corresponding value should be saved in a Member's personal account for usage at a later date.” Credits ensure that the member does not lose any money because it is stored for future use. Members can use a wide variety of products and services both in and out of the club. The essence of the present invention is that members will only be charged for what they use. Credits enable members to fully personalize their membership.

Credits ensure VP (value purchased)=VR (value received). Credits offer membership flexibility creating enjoyment through alternative services. Credits enable the club to offer a membership that follows the members wherever they go. The present invention enables participation in a global network of leading Clubs united under a strong branded platform.

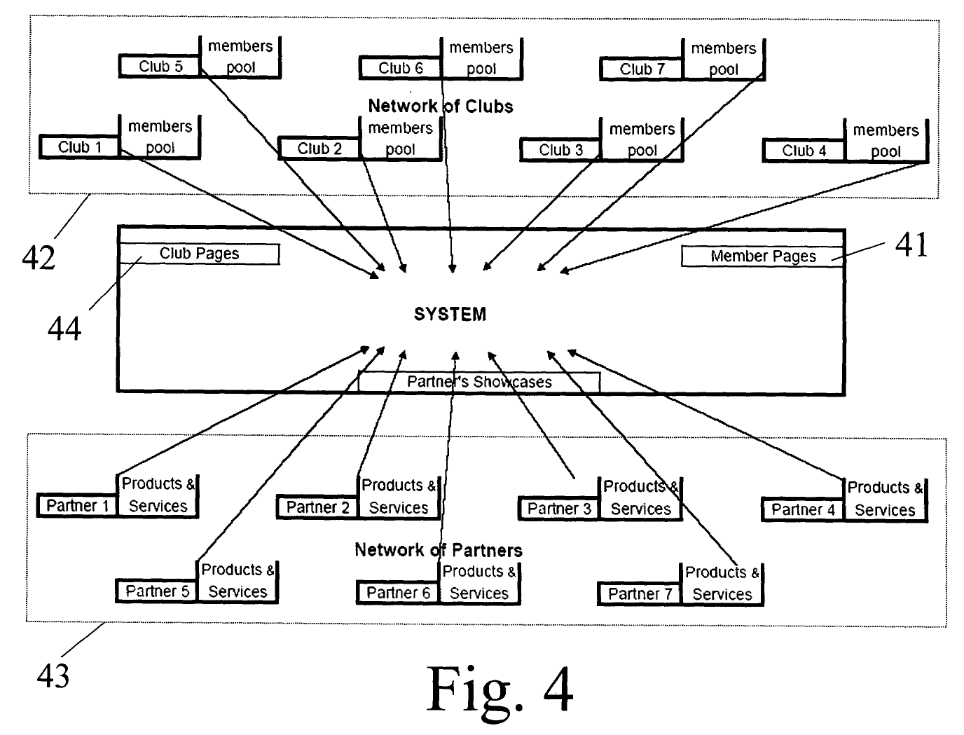

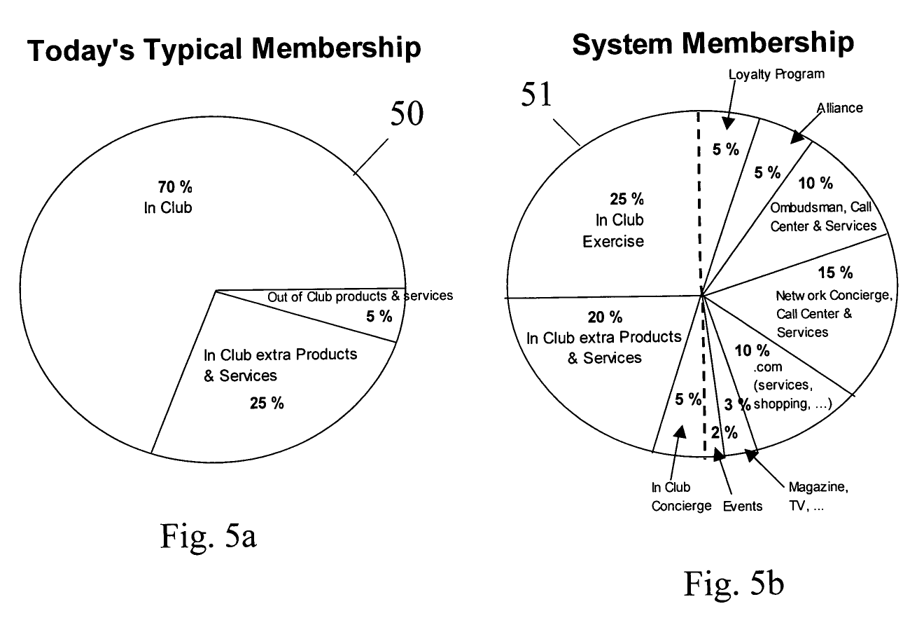

The system features a membership model structured around flexible usage of club services 51 in order to offer members tangible value, beyond current time-lapse memberships 50 as shown in FIGS. 5a and 5b. Value Purchased is converted to Credits and stored on one of the pay-for-use accounts/cards until redeemed.

TABLE 1
Comparison Chart of the prior art vs. the present invention.

| Old Generation Time-Lapse | |
|---|---|
| membership | Present Invention Membership |
| Cost of annual membership: $540.00 | For the same: $540.00 |
| Club usage: 104 days | And the same Club usage: |
| | 104 days |
| Percent of unused days: 71.5% | And the same unused days: |
| | 71.5% |
| Money paid and not used: $386.10 | Money paid and not used: |
| | $386.10 |
| Money Lost: $386.10 | Money Saved: $386.10* |

*This money is stored in the member's personal account and can be redeemed under the present invention system in a variety of other products and services both in and out of the club. This is the core of the system's innovation: allowing members to receive all their money's worth while at the same time giving each member unlimited personalization of when, where and how to get value from their membership.

The present invention stores the member's value that would normally have been wasted. The unused value can then be used on a variety of products and services in and out of the club.

Four instruments are required by the system to ensure the accurate, responsible, consistent and transparent fulfillment of the System's commitments to its members and partners worldwide: The on-line Ombudsman service; The success foundation, a training institute for sales people of the clubs; The innovation awards, that offer rewards to members with innovative suggestions; and The Member's Protection Bond, a monetary pool of ‘goodwill’ created by member clubs to ensure members are always covered.

The proposed invention, in a preferred embodiment, provides a method to make a membership rewarding by removing all of the concerns out of joining a club. The present invention may be implemented for any membership in the same manner it is for a health club membership. The present invention provides means for storing the value of a club membership on a card, to use when and where one wishes to do so. By a proprietary to each industry formula it converts the money paid by the member to Value Purchased and stores it in a personal account. This not only eliminates financial risk, but also facilitates the ability to choose one's personal preferences out of their club membership.

Access Cards are exclusively offered to members of participating or endorsed clubs. All clubs within the network are required to satisfy the highest standards as a condition to receiving and maintaining the endorsement. The present invention makes club membership an essential ingredient of everyday life, where members are in control, enjoy use tailored to their needs and receive value for their money.

The present invention enables a member to store the value of a member's membership on a personal account and access it through their Access Card, computer, cell phone or any other device that can be used to access a personal account stored in a computer over the web. The present invention permits a member to use a variety of products and services, both in the club and out of the club in the networks of affiliated clubs and partners. This allows a member to fully personalise the use of their club membership and maximizes the value of their investment.

The first step of the present invention provides that for every day a member does not use their club membership, the corresponding value is saved in the member's personal account for usage at a later date for or another purpose. This enables a member to pay only for the services they use and nothing more.

The second step in the process enables a member to choose which services to use and when and how to use them throughout the duration of a member's membership as a member's needs evolve.

A third step in the process provides means for a member should be able to access a member's membership whenever and wherever a member wants to access it. A member's account can be accessed not only at a member's Home club 44, but also through a member's personalized web page 41 at t a Global Service Centre; or any of the network's clubs 42, as shown in FIG. 4

Credit or credits, as used in this application is defined as a unit established for use as a basis of comparison in measuring usage; the basis for the measure of value in the system; where usage is the true and only measure of the derived benefit, i.e. value.

The present invention enables a member to use a member's credits in the club for a variety of services and products in the club and makes them redeemable out of the club for a wide variety of other services and products through the partner's network 43.

There are at least three unique cards/accounts catering for different levels of commitment. All of the cards offer Value Purchased always equals Value Received. Thus, whatever type of card a member chooses to store the value of a member's club membership on, a member's money will not be wasted.

There are different types of Access Cards/Accounts for different commitment levels. Commitment levels are measured in duration of membership and/or frequency of weekly use. For each type of access card/account, there are two levels, based on payment options: the Basic (first) level is pay-as-a-member-goes or direct debit and the Premium (second level) are pre-financed. Pre-financed cards/accounts can be paid either through any bank guaranteed method of payment or cash-in-advance. Pre-financed cards can be differentiated by their visual appearance over the pay-as-a-member-goes card level.

The system recommends three account/card types ideally but more are possible and provided by the system. Each card type caters to a different level of commitment. Commitment levels are measured by the system in regards to duration of commitment and frequency of use. So a month-to-month membership would be a different level than an annual membership. Also once a week commitment would be a different level than commitment to use three times a week.

Each account/card type carries a different credit Accrual Rate to store value purchased ranging from Basic to Optimum resulting in a different cost for value ratio per card type. Membership Value is Converted to Credits. The system enables A Member to store the value of a Member's fitness club membership on a Member's System card in Credits. Credits are issued by, and credited to, the cardholders account by the Home club. Credits may be earned from the commencement of membership through to its expiry. The number of Credits credited to a Member's Access Card depends on the System Program conditions applying to the Access Card in question at the date of activation. The payment of membership fees for any period entitles A Member to receive enough Credits on a Member's Access Card to enable A Member to visit a Member's Home club for as many days in that same period, as the membership agreement with a Member's club provides for. If a prepaid membership is selected by a member, all Credits pertaining to the entire period of membership are earned and credited immediately following activation of the Access Card.

If a member prepays all or part of a membership at any time during the term of the membership, all credits pertaining to the prepaid value are earned and credited immediately following the payment. If a monthly payment option is selected by a member, Credits are earned and credited to the Access Card following each membership payment. No Credits are earned or credited in the case of Home club membership for which the Cardholder receives benefits under another bonus program. Automatic crediting of Credits to a Cardholder's account occurs every time the Cardholder makes a payment on his Home club membership or tops up his Access Card. Credits are not credited to lapsed or cancelled Access Cards.

Also depending on the account type, different services are available for use to the member ranging from Core to All Inclusive. Different privileges also come with each account level. In addition a fixed percent of compensation for past failures comes with each account type ranging from 25% of previous membership fees and no entry fees compensated to 100% of both compensated.

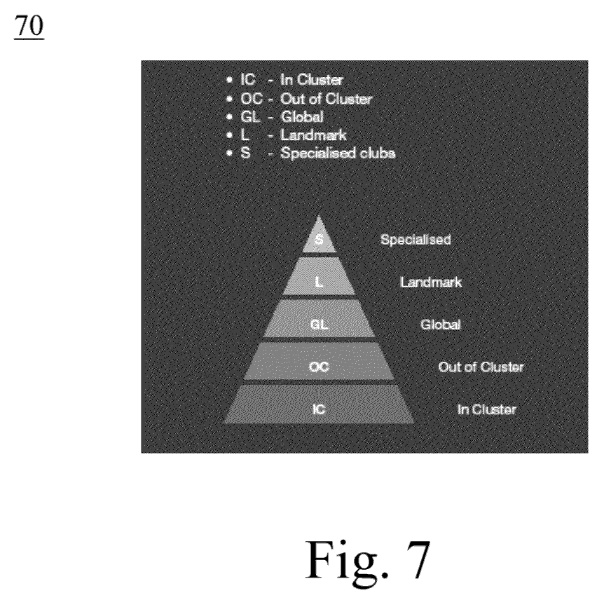

Services offer by the present invention include: a website, Partners, e-shop, Concierge, and Ombudsman. As shown in FIG. 7, Network Access Rights granted include: In Cluster, Out of Cluster, Global, Landmark, and Specialized. Privileges are defined as: Upgrade, Expand, Replenish, Freeze, Discontinue, Refresh, Share, Refer, Transfer Home, and Multiple Home.

The highest-level account gives superior recognition to its members and combines the optimum credit accrual rate, the most network rights, privileges and the most variety of services offered at the best overall cost for value ratio along with priority bookings and special privileges from partners.

The Premium levels of all accounts/cards provide maximum spending power as the immediate release of all the credits and other compensation allows cardholders spending flexibility.

A member's card is protected with a Personal Identification Number (PIN). To activate a member's card, a member must choose and enter a member's PIN at the reception of a member's Home club. A member can change a member's PIN at any time either on the website or at a member's Home club. Each System membership allows members to redeem Credits in exchange for vouchers to use in other Network Clubs. The exact number of Credits that A Member can—if A Member wish—redeem against Network Club vouchers depends on a Member's choice of Home club. The larger the chain a Member's Home club belongs to, the greater the Network Access Rights as shown in Table 2: Example: A home club belonging to a chain of 10 clubs: 10%+(0.1%×10)=11% of each memberships credits can be redeemed against network vouchers.

TABLE 2

| Home Club | Network Redeemable Credits |
|---|---|
| Stand Alone | 10% of membership credits |
| Belongs to a Chain | +0.1% per club |

The System distinguishes between five different types of Home Clubs, for Network Access Rights purposes: IC—In Cluster: The System identifies as “In Cluster” the Network clubs located in the immediate geographical area of a Member's Home club. OC—Out of Cluster: The System identifies as “Out of Cluster” the Network clubs located within the same country of a Member's Home club, but outside of a Member's Home club's “In-Cluster” area. GL—Global: The System identifies as “Global” the Network clubs located outside of the country that a Member's Home club is located. L—Landmark: Clubs with extremely high standards can be classified as Landmark by the System. Clubs that are classified as “Landmark” can be found on the System's website. S—Specialized: Clubs that offer very distinct services can be classified as Specialized by the System. Examples of “Specialized” clubs are airport clubs or clubs for people with special-needs. Clubs that are classified as “Specialized” can be found on the System's website. FIG. 7 shows Network Classification Pyramid 70.

Network Access rights vary depending on the location of the System club A Member want to visit and a Member's card type. A Member cannot visit in Cluster Clubs of the network. If a Member's Home club belongs to a Club Group, which operates other clubs within the “In Cluster” area of a Member's Home club A Member may have multi-site access rights depending upon a Member's membership terms. This Club Group multi-site use will not affect Credits with Network Voucher Redemption Rights. Subject to availability of Credits with Network Voucher Redemption Rights, during any three month period A Member can visit “Out of Cluster” clubs of the network up to 10 times each. Subject to availability of Credits with Network Voucher Redemption Rights, during any three month period A Member can visit each “Global” club of the network, up to 15 times. Subject to availability of Credits with Network Voucher Redemption Rights, during any calendar year A Member can visit each “Landmark” club of the network once.

Subject to availability of Credits with Network Voucher Redemption Rights A Member can access a “Specialized” club by paying for each visit 70% in cash and 30% using Network Rights. If a Member's Home club is in the same “In Cluster” area as the “Specialized” club A Member cannot redeem visits at that “Specialized” club.

All Network clubs are equipped with a card-swipe. To use a member's Home club's facilities, simply swipe a member's card at the entrance to gain access to a member's Home club and enter a member's PIN. Access will automatically be granted providing a member having sufficient Credits available on a member's card.

The present invention enables a member to store the value of a member's club membership on a member's card in Credits. Credits are issued by, and credited to, the cardholders account by the Home club. Credits may be earned from the commencement of membership through to its expiry. The number of Credits credited to a member's Access Card depends on the Program conditions applying to the Access Card in question at the date of activation. In any event, the payment of membership fees for any period credits a member's Access Card with enough Credits to enable a member to visit a member's Home club every day in that same period.

In the event that the prepaid option is selected by a Cardholder, all Credits pertaining to the entire period of membership are earned and credited immediately following activation of the Access Card.

Where a monthly payment option is selected by a cardholder, Credits are earned and credited to the Access Card following each membership payment.

Other ways to earn Credits that may be available from time to time and the relevant conditions are announced separately in the communication media.

Automatic crediting of Credits to a Cardholder's account occurs every time the Cardholder makes a payment on his Home club membership or tops up his Access Card. Credits are not credited to lapsed or cancelled Access Cards.

A member may redeem Credits as soon as they have been earned and are credited to a member's account. A member may redeem Credits at any time within the Full Redemption Period. Credits can be redeemed in a member's Home club: for Home club visits; and for Home club core basic services and depending on the card type other Home club products and services. Credits can also be redeemed in a member's Home club in combination with cash in accordance with specific offers made available from time to time by a member's Home club. A member's account/card is issued by a member's Home club, whose services can vary from those offered at other clubs.

Redemption cost of each club visit varies from club to club. Cost may also vary depending on the time a member enters the club (peak, regular or off-peak hours). Peak and off-peak hours are publicized by each club and may vary from season to season. If a member visit a club more than once within the same calendar day a member will not be charged for an extra visit. During each visit to a club a member may use the standard workout services provided by the club. To receive information on the redemption value of a visit in any network club, a member should consult the Representative at a member's Home club or the Program website.

Each Home club publicizes a Credit redemption catalogue of all services and products offered for redemption to its Cardholders. Depending on the service or product, this catalogue lists prices in cash, Credits or combined cash and Credits.

Having joined a club, a member has made a decisive first step towards a healthier lifestyle. Now that a member has made that commitment, the present invention will assist and encourage a member in achieving maximum benefit from it. For example, the present invention will reward a member for good lifestyle choices and compensate a member for any past or future disappointments. The second unique method of the present invention facilitates other non-monetary compensation (ONMC)

Other compensation are issued by, and credited to the Cardholder's account by the present invention. A member having received a member's personal other non-monetary compensation voucher can be transferred to a member's account at the reception in a member's Home club. A member can earn additional other non-monetary compensation for: frequent use, good lifestyle decisions, upgrades, referrals, and replenishment compensation.

While Credits can be used for services and products offered in the Home clubs and to purchase services at other Network Clubs, Other compensation can be used for all services and products offered by providers outside the clubs. All Credits which have expired (if not ‘refreshed’ within the 4 week period that follows the expiry of the Full Redemption Period), are automatically converted to other non-monetary compensation. Cardholders can at any time cancel Credits and be issued with other c non-monetary compensation. A Member may redeem Credits as soon as they have been earned and are credited to a Member's account. A Member may redeem Credits at any time within the Full Redemption Period. Credits can be redeemed IN a Member's Home club for Home club visits or for Home club core basic services. Credits can also be redeemed in a Member's Home club in combination with money in accordance with specific offers made available from time to time by a Member's Home club. Credits can be redeemed IN the network for club visits only, subject to a Member's Access Card's Network Rights.

A Member's Credit personal statement informs A Member of all a Member's transactions. Redemption cost of each club visit varies from club to club. Cost may also vary depending on the time A Member enter the club (peak, regular or off-peak hours). Peak and off-peak hours are publicized by each club and may vary from season to season. If A Member visit a club more than once within the same calendar day A Member will not be charged for an extra visit. Each Home club publicizes a Credit redemption catalogue of all services and products offered for redemption to its System Cardholders. Depending on the service or product, this catalogue lists prices in cash, Credits or combined cash and Credits.

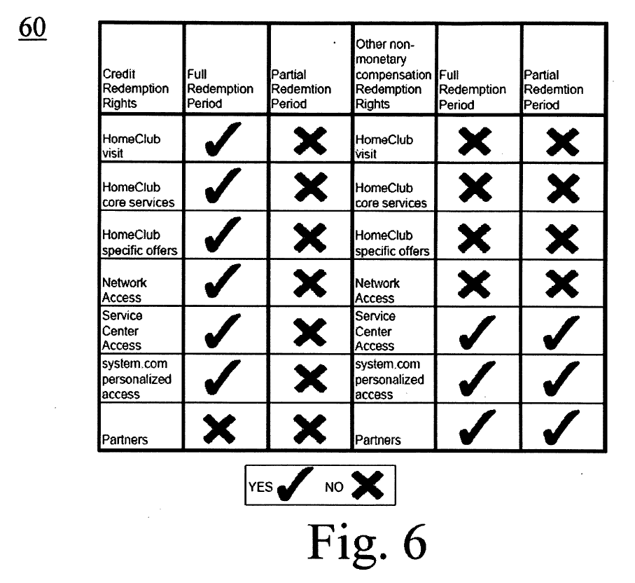

A redemption period is the duration in which Credits and/or ONMCs may be exchanged for specific products and/or services. The system differentiates between two redemption periods for Credits and ONMCs (other non-monetary compensation). The two redemption periods are: Full Redemption Period and Partial Redemption Period. The Full Redemption Period starts when the membership starts. Duration of Full Redemption Period varies with membership levels. During Full Redemption Period both Credits and ONMC can be redeemed. The Partial Redemption Period starts at the end of Full Redemption Period. Duration varies with membership levels as shown in Table 3. During Partial Redemption Period only ONMCs can be redeemed. FIG. 6 shows redemption rights 60 for each period for Credits and ONMCs. Any Credits left unused on a Member's card at the end of the Full Redemption period may be: ‘refreshed’ within 4 weeks; or automatically cancelled and ONMCs awarded to member account.

The System also provides for a Post Redemption Period. This period starts at the end of the Partial Redemption Period. Duration of Post Redemption Period varies with membership levels. All redemption rights expire at the start of this period and any ONMC balance shall at this time be cancelled by the System. During the Post Redemption Period, ONMCs can be reinstated if the member purchases a new membership.

TABLE 3
Redemption Periods

| | Full | Partial | Post |
|---|---|---|---|
| Commitment | Redemption | Redemption | Redemption |
| Levels | Period | Period | Period |
| Level 1: 1 yr. | 1 yr. | +1 yr. | +1 yr. |
| Level 2: 2 yrs. | 2 yrs. | +2 yrs. | +2 yrs. |
| Level 3: 3 yrs. | 3 yrs | +3 yrs | +10 yrs |

The Formula to calculate Redemption Period Durations is: if commitment level is less than 3 years, then: Full redemption period equals the level of commitment. Partial redemption period equals the level of commitment. Post redemption period equals the level of commitment. For example: a 1 Month Membership (i.e. Commitment Level 1 Month); Full Redemption Period=1 month, Partial Redemption Period=1 month, and Post Redemption Period=1 month. If commitment level is 3 years or more, then: Full redemption period equals the level of commitment. Partial redemption period equals the level of commitment. Post redemption period equals 10 years.

A member's Credit statement of account from a member's Home club is available online under the ‘My Statement’ section of the website of the present invention or at a member's Home club's reception upon request. The Cardholder's Account is updated by a member's Home club on a daily basis. This account provides a member with a detailed analysis of every transaction a member have made in Credits as well as a member's current account balance. ‘My Statement’ also details all transactions effected since activation of a member's card (including such information as date, value, time and type of redemption or accrual). In the ‘My Statement’ section, a member can also find a separate statement of a member's other compensation that contains the same level of detail as a member's Credit statement of account.

Claims based on discrepancies must be filed with the Home club within one month of its first display in a member's personal online accounts. Thereafter, the transactions and account balance as stated are considered approved.

A member's card comes with a number of global services, rights and privileges that are designed to enhance and protect a member's club membership investment. A condition to every club within the Network obtaining and maintaining endorsement and access to the system is continued compliance with certain standards. The imposition of these standards is designed to protect not only the value and integrity of a member's membership investment but also the reputation of the Network Clubs. In the event that a club falls short of these standards, a Citation may be issued against the Club. Failure to comply with a Citation will result in its publication on the website and may be followed by removal of Endorsement.

An Ombudsman is at a member's service. A member can communicate any request, concern or query to this service by posting or faxing a letter, e-mailing a message, accessing a member's personal page, or calling the Global Service Centre. The Ombudsman investigates complaints and mediates fair settlements between, for example, cardholders and club operators. The Ombudsman can further compensate valid complaints in the form of Credits or Other compensation.

The Concierge is a member's human link with the world that acts as a member's personal expert and guide who helps a member take off to a colourful horizon of experiences and emotions in the world.

The website of the present invention is much more than just a traditional business website. It is a communication portal enabled for relationship management that has the capability to maintain personal membership accounts and membership usage history.

A member can conveniently access the exciting world of online wherever a member is located. The first time a member visit the website of the present invention, a member will be asked to log in and enter a member's username and password. The system will ask a member to enter a member's card number and the PIN a member chose at a member's Home club. A member can now set a member's personal username and password, which can be used for all future visits.

Once a member has logged on to the website, a member's personal “My Membership” page will appear. To obtain maximum benefit as a Cardholder, a member should first set a member's personal preferences. This will enable the system to inform a member of all exciting events, products and services specific to a member's interests and ensure that a member does not waste time searching through services and products that a member has little interest in. A member is now ready to explore and use the online world.

The method of the present invention requires partnering with high quality providers of products and services relevant to the member's lifestyle and integrate them into the system. The website informs cardholders of the products and services available from these partners, recommending which of them would best satisfy cardholders' individual needs. Through the system, cardholders have access to exceptional discounts and/or preferential treatment designed by the partners solely with the cardholders in mind.

Each card allows cardholders to redeem Credits in return for vouchers to use other Network Clubs. This enables a member to have continuous and uninterrupted service when a member gets caught on the other side of town, or moves around the country or even travels internationally as the network grows. The present invention also wants a member to find a ‘home away from home’ in each Network Club where a member feels welcome and can go to work out, relax, meet with other cardholders or get local assistance. The exact number of Credits that a member can—if a member wishes—redeem against Network Club vouchers depends on a member's Home club. The larger the chain a member's Home club belongs to, the greater the Network.

Referring to FIG. 7, Network clubs are identified in categories and network access rights are established by the present invention as follows:

The System distinguishes between five different types of Home Clubs, for Network Access Rights purposes: IC—In Cluster: The System identifies as “In Cluster” the Network clubs located in the immediate geographical area of a Member's Home club. OC—Out of Cluster: The System identifies as “Out of Cluster” the Network clubs located within the same country of a Member's Home club, but outside of a Member's Home club's “In-Cluster” area. GL—Global: The System identifies as “Global” the Network clubs located outside of the country that a Member's Home club is located. L—Landmark: Clubs with extremely high standards can be classified as Landmark by the System. Clubs that are classified as “Landmark” can be found on the System's website. S—Specialized: Clubs that offer very distinct services can be classified as Specialized by the System. Examples of “Specialized” clubs are airport clubs or clubs for people with special-needs. Clubs that are classified as “Specialized” can be found on the System's website. FIG. 7 shows Network Classification Pyramid 70.

Network Access rights vary depending on the location of the System club A Member want to visit and a Member's card type. A Member cannot visit in Cluster Clubs of the network. If a Member's Home club belongs to a Club Group, which operates other clubs within the “In Cluster” area of a Member's Home club A Member may have multi-site access rights depending upon a Member's membership terms. This Club Group multi-site use will not affect Credits with Network Voucher Redemption Rights. Subject to availability of Credits with Network Voucher Redemption Rights, during any three month period A Member can visit “Out of Cluster” clubs of the network up to 10 times each. Subject to availability of Credits with Network Voucher Redemption Rights, during any three month period A Member can visit each “Global” club of the network, up to 15 times. Subject to availability of Credits with Network Voucher Redemption Rights, during any calendar year A Member can visit each “Landmark” club of the network once.

Subject to availability of Credits with Network Voucher Redemption Rights A Member can access a “Specialized” club by paying for each visit 70% in cash and 30% using Network Rights. If a Member's Home club is in the same “In Cluster” area as the “Specialized” club A Member cannot redeem visits at that “Specialized” club.

To access a Network club use a member's card and PIN to enter in the same way that a member would at a member's Home club. A member's personal account with a member's Home club will be accessed automatically to obtain the necessary voucher. Entry will be denied by the Home club if access rights are being violated or Credits with Network Voucher Redemption Rights are not available on a member's account.

The present invention also provides for privileges, which are intended to accommodate and protect members in cases of unexpected changes in their life and/or the conditions in their Home club. Privileges are provided by the present invention in order to safeguard members. The system provides for ten different privileges: upgrade, expand, replenish, freeze, discontinue, refresh, share, refer, transfer home, and multiple homes.

Privileges exist to safeguard members not attract them. Privileges are intended to accommodate and protect members in cases of unexpected changes in their life and/or the conditions in their Home club. The System offers members ten different Privileges:

The first privilege is Upgrade. A member can upgrade from a lower level card to a higher-level card as follows: First purchase the higher-level card. The value of the remaining Credits on a member's former card will be converted back into cash value using the old card's Credit Accrual Rate and reissued to a member's new card at the new card's Credit Accrual Rate. A member may gain Credits in the process because higher-level cards have a more preferential Credit Accrual Rate.

The second privilege is Expand. The system can also expand a Member's card to include family members in the membership. The system considers “family” first degree relations—such as the husband, wife, cohabiting couples, son, daughter, brother, sister, father or mother of the cardholder—who share the same income and reside with the member. Family Cards are issued to adult family members. Dependant Cards can be issued by the Home Club to allow minors to access “parent” account and draw Credits from, for Club use by the minors. If a member and a member's spouse and/or co-habitee partner are cardholders, a member can “expand” a member's card to allow a member's children under 18 years old to be issued special ‘dependant’ cards provided that the rules of the Home club permit children of the age group in question to assume membership. No charges are imposed for these cards other than a small fee to cover the cost of the cards. The dependant cards access the ‘parent’ account from which they draw Credits when they are used. A member can choose which of the two ‘parent’ accounts will be used to tie in each of the dependant cards. When a child reaches the age of 18, the system automatically deactivates the dependant card.

The third privilege is Replenish. A member can, at any time during their Full Redemption Period, ‘replenish’ their card by purchasing one or more increments of ten Credits at the Credit Accrual Rate of their membership. The newly accrued Credits expire at the end of the Full Redemption Period of a Member's membership.

The forth privilege is Freeze. A Member can ‘freeze’ a Member's System membership during the Full Redemption Period for a term between 3 and 12 months and only for reasons of: Inability to use membership due to illness, injury or temporary disability; Temporary relocation to new address not within a reasonable range of the Home club; Army service; and Pregnancy. When a card is ‘frozen’, payments and Credits accrue but the Full Redemption Period is extended by the period of ‘Freeze’. The ‘freeze’ ends automatically when automatically when a year passes or if a member uses their membership. ‘Freeze’ cannot be back-dated except for reason of inability to communicate due to serious disability and even then only with the Ombudsman's approval.

The fifth privilege is Discontinue. A ‘Cooling-off Period’ occurs during the initial seven days of becoming a cardholder, a member can discontinue their card by returning it to the Home club. They will be reimbursed such sums as they have paid to the Home club less the value of any Credits redeemed to date.

After the ‘Cooling-off Period’, and during the Full Redemption Period, a member can discontinue their card at any time without any cost by returning it to the Home club. Any Credits paid for and/or spent shall be non-refundable and non-redeemable and will be cancelled by the Home Club and all award and reward rights will be lost.

Upon discontinuation: In the event that a member has unused Credits that are cancelled upon discontinuation, they may be eligible to receive ONMCs which can be redeemed over the Partial Redemption Period.

Suspension: The Home club reserves the right to suspend or discontinue a card under the terms of the cardholder agreement with the Home club. A member's card is also automatically suspended upon cancellation of their Home Club membership.

The sixth privilege is Refresh. At the end of the Full Redemption Period, unredeemed Credits expire and are automatically cancelled by the Home club. During the four (4) weeks following the end of the Full Redemption Period, a member can ‘refresh’ their ‘aged’ Credits by purchasing a new Home club membership. Any balance of Credits and ONMCs from their old card will be reinstated to that new card. Aged Credits will be refreshed (i.e. validated again for use until the expiry of the Full Redemption Period of the new membership).

The seventh privilege is Share. A member can occasionally bring a guest in to their Home Club with them and charge their visit to their card by accessing the Share System option at the gate of their Home club. Guests are not allowed to visit Network clubs. Steps are: A guest can visit a Home Club up to five times. The level of a membership dictates the total number of guest visits a member is entitled to as shown in Table 4.

TABLE 4

| Commitment Levels | Guest Visits |
|---|---|
| Level 1: 1 yr. | 30 |
| Level 2: 2 yrs. | 15 |
| Level 3: 3 yrs. | 5 |

The eighth privilege is Refer. Members receive a reward of 5,000 ONMCs for any referral to their Home Club that becomes a member.

The ninth privilege is Transfer Home. A Member can transfer their card to another club within the Network if they permanently relocate to an area not within a reasonable range of their Home Club and close to another Network club. ‘Transfer Home’ applies only to Level 3 cards and above. The steps to transfer area as follows: Membership must be over six months; the Home Club will cancel the membership and all Credits will be automatically cancelled by the Home Club; a replacement card will be issued to the member by the new Home Club; and an ONMC balance will not be lost and it will continue to be available for use on member's card.

The tenth privilege is Multiple Home. Members can have more than one Home Club account. ‘Multiple Homes’ applies only to Level 3 cards and above. The steps for multiple homes is as follows: Become a System member at any Home Club; purchase subsequent cards from other Home clubs; and top them up with increments of no less than 50,000 Credits. Members can only apply for ‘Multiple Home’, during the Full Redemption Period of their card. All cards issued to members under ‘Multiple Home’ have the same Full Redemption Period expiry date as their original card.

If a member's original card is cancelled for any reason then the subsequent cards/accounts will ‘freeze’ until a member settle the difference between all sums a member would have paid had a member not purchased subsequent cards under the ‘Multi Homes’ Privilege (but rather in accordance with normal rules) and the sums a member have in fact paid. Access will be suspended until the matter is settled with the Ombudsman.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method of membership management, recorded on computer-readable medium and capable of execution by a computer, comprising the steps of:
allowing a user to store the value of their club membership on a personal account/access card;
facilitating choosing one's own personal preferences out of their club membership;
accumulating credits with a monetary value;
spending accumulated credits to purchase goods or services;
spending when services are used, eliminating waste;
spending in and out of the club with partners;
communicating and networking among members; and
maintaining an open communication channel between members and partners.

2. The method of membership management of claim 1 further comprising Account/card types per industry established for different commitment levels measured in duration of membership and frequency of weekly use and payment options including Pay-as-a member-goes and pre-financed.

3. The method of membership management of claim 1 where a Member chooses account/card types to store membership on.

4. The method of membership management of claim 1 where VP is translated to Value Units using the specific to the industry formula used by the system for the selected account type.

5. The method of membership management of claim 1 where the system also defines a calculator tool shown in FIG. 3 along with all the proprietary formulas developed for each industry.

6. The method of membership management of claim 1 where Membership Value is stored in personal container in pts.

7. The method of membership management of claim 1 where containers can be personal, couple, family, or household.

8. The method of membership management of claim 1 where the system also defines Accrual rules.

9. The method of membership management of claim 1 further comprising redemption rules.

10. The method of membership management of claim 1 further comprising redemption periods.

11. The method of membership management of claim 1 further comprising price lists established by each issuer club and entered in the system in pts for some services and pts combined with cash for other services for redemption use by members.

12. The method of membership management of claim 1 further comprising these Participants:
issuer is a home club;
owner is a member;
facilitator;
network of clubs; and
network of partners.

13. The method of membership management of claim 1 where the Network of Partners is formed around each club and Partners gain communication access to members in exchange for discounts offered.

14. The method of membership management of claim 1 wherein Network Access Rights and Network Clubs are defined.

15. The method of membership management of claim 1 wherein Privileges offered to members are defined by the system.

16. The method of membership management of claim 1 wherein a process to issue Rewards for good choices is defined by the system.

17. The method of membership management of claim 1 further comprising Compensation for: past disappointments; current system failures; and innovative suggestions.

18. The method of membership management of claim 1 wherein Services offered by the system include: a website, Partners, e-shop, Concierge, and Ombudsman.
